(19) United States
(12) Patent Application Publication
(10) Pub. No.: US 2024/0187341 A1
(43) Pub. Date: Jun. 6, 2024

(54) IOT CONNECTION SYSTEM, INFORMATION PROCESSING METHOD, AND COMPUTER PROGRAM

(71) Applicant: IoT-EX Inc., Tokyo (JP)

(72) Inventor: Jun MATSUMURA, Tokyo (JP)

(73) Assignee: IoT-EX Inc., Tokyo (JP)

(21) Appl. No.: 17/799,282

(22) PCT Filed: Feb. 3, 2021
(86) PCT No.: PCT/JP2021/003983

§ 371 Date: Sep. 8, 2022

(30) Foreign Application Priority Data
Feb. 14, 2020 (JP) 2020-023198

(51) Int. Cl. H04L 45/741; H04L 12/46

(52) U.S. Cl. CPC H04L 45/741; H04L 12/4604

(57) ABSTRACT

Attractive services are provided by freely interconnecting IoTs via the Internet.

An IoT connection system includes an IoT hub and an IoT router. The IoT hub includes at least one of a first driver and a second driver, the first driver being used to connect the IoT hub to a private cloud to which a first device is connectable, and the second driver being used to connect a second device and the IoT hub, the IoT router includes a third driver for connecting a third device and the IoT router, and the IoT hub executes a continuous connection function for continuously connecting the first device, the second device, the third device, and an IoT service that is usable via the IoT hub to each other, and a directory function for associating the first device, the second device, the third device, and the IoT service with each other.

### TECHNICAL FIELD

The present disclosure relates to an IoT connection system, an information processing method, and a computer program.

### BACKGROUND ART

In recent years, the number of devices that can connect to the Internet and receive various services has begun to increase. Such devices are referred to as Internet of Things (IoT) devices.

Since each of such IoT devices is generally connected to a dedicated private cloud, it is usually not possible to connect IoT devices with different specifications manufactured by different manufacturers to the same private cloud.

In recent years, an IoT cloud service referred to as an IoT hub capable of connecting IoT devices manufactured by various manufacturers by publishing an application programing interface (API) for connection to a cloud and providing a software development kit (SDK) or the like has also been provided (Non Patent Literature 1, Non Patent Literature 2, and the like).

### CITATION LIST

### Non Patent Literature

[Non Patent Literature 1] “Azure IOT Hub”, Microsoft Corporation, [retrieved on Jun. 2, 2019], the Internet <https://azure.microsoft.com/ja-jp/services/iot-hub/>
[Non Patent Literature 2] “AWS IoT”, Amazon Web Services, Inc. [retrieved on Jun. 2, 2019], the Internet <https://aws.amazon.com/jp/iot/>

### SUMMARY OF INVENTION

### Technical Problem

Although the above-mentioned IoT cloud services exist, association between the services is limited, and it is necessary for a business operator of an IoT device to develop a dedicated connection program for each service and incorporate the program into the device.

For this reason, an object of the present disclosure is to provide attractive services by freely interconnecting the IoT in daily life, which is in a siloed state for each private cloud, via the Internet.

### Solution to Problem

An IoT connection system in an embodiment of the present disclosure is an IoT connection system that includes an IoT hub implemented on a cloud, and an IoT router locally located and connected to the IoT hub. The IoT hub includes at least one of a first driver and a second driver, the first driver being used to connect the IoT hub to a private cloud to which a first device is connectable, and the second driver being used to connect a second device and the IoT hub, the IoT router including a third driver for connecting a third device and the IoT router, and the IoT hub implementing a continuous connection function for continuously connecting the first device, the second device, the third device, and an IoT service that is usable via the IoT hub to each other, and a directory function of associating the first device, the second device, the third device, and the IoT service with each other.

The directory function may be used to specify the first device, the second device, the third device, or the IoT service and give an instruction to the first device, the second device, the third device, or the IoT service.

The directory function may be used to specify an association destination device designated by an association source device on the basis of identification information of a device, identification information of a driver, and identification information of a connection interface.

The directory function may be used to further specify the association destination device, on the basis of identification information of the IoT hub.

The identification information of the device, the identification information of the driver, and the identification information of the connection interface are stored in a predetermined storage device, and the storage device may further store identification information of a connection source device for which connection is not permitted, and/or a function of the device as a whitelist.

At least one of the first driver, the second driver, and the third driver may implement a virtual device function for virtually reproducing the first device, the second device, or the third device.

The IoT hub may further include a Web API for using an IoT application.

Information acquired from the first device, the second device, or the third device may not be stored in the IoT hub.

The IoT router may be able to be remotely controlled by an administrator device.

An information processing method in an embodiment of the present disclosure is an information processing method in an IoT connection system including an IoT hub implemented on a cloud, and an IoT router locally located and connected to the IoT hub, the IoT hub including at least one of a first driver and a second driver, the first driver being used to connect the IoT hub to a private cloud to which a first device is connectable, and the second driver being used to connect a second device and the IoT hub, the IoT router including a third driver for connecting a third device and the IoT router, the information processing method including causing the IoT hub to execute a continuous connection step of continuously connecting the first device, the second device, the third device, and an IoT service that is usable via the IoT hub to each other, and a directory step of associating the first device, the second device, the third device, and the IoT service with each other.

A computer program in an embodiment of the present disclosure is a computer program executed by an IoT connection system including an IoT hub implemented on a cloud, and an IoT router locally located and connected to the IoT hub, in which the IoT hub includes at least one of a first driver and a second driver, the first driver being used to connect the IoT hub to a private cloud to which a first device is connectable, and the second driver being used to connect a second device and the IoT hub, and the IoT router includes a third driver for connecting a third device and the IoT router, the computer program causing the IoT hub to execute a continuous connection function for continuously connecting the first device, the second device, the third device, and an IoT service that is usable via the IoT hub to each other, and a directory function for associating the first device, the second device, the third device, and the IoT service with each other.

### Advantageous Effects of Invention

According to the present disclosure, it is possible to provide attractive services by freely interconnecting IoT in daily life, which is in a siloed state for each private cloud, via the Internet.

According to an embodiment of the present disclosure, not only IoT devices that are directly connected to each other, but also IoT devices that are connected to a private cloud of the related art can be easily interconnected.

In addition, according to an embodiment of the present disclosure, it is possible to provide an IoT connection system, a computer program, and an information processing method which are capable of continuing services even when an IoT device cannot be connected to a network due to a power failure or the like.

### BRIEF DESCRIPTION OF DRAWINGS

FIG. 1 is a system configuration diagram illustrating an example of a configuration of an IoT connection system according to an embodiment of the present disclosure.

FIG. 2 is an image diagram illustrating an example of a plurality of private clouds of the IoT connection system according to the embodiment of the present disclosure.

FIG. 3 is an image diagram illustrating an example of a plurality of first devices connected to the private clouds of the IoT connection system according to the embodiment of the present disclosure.

FIG. 4 is an image diagram illustrating an example of a flow of a service provided in the IoT connection system according to the embodiment of the present disclosure.

FIG. 5 is a hardware configuration diagram illustrating a hardware configuration of an IoT router according to the embodiment of the present disclosure.

FIG. 6 is an image diagram illustrating an example of a flow of a service provided in the IoT connection system according to the embodiment of the present disclosure.

FIG. 7 is an image diagram illustrating a connection interface of the IoT connection system according to the embodiment of the present disclosure.

FIG. 8 is an image diagram illustrating another example of a flow of a service provided in the IoT connection system according to the embodiment of the present disclosure.

FIG. 9 is an image diagram illustrating an example of a flow of a virtual driver function provided in the IoT connection system according to the embodiment of the present disclosure.

FIG. 10 is an image diagram illustrating another example of a flow of a virtual driver function provided in the IoT connection system according to the embodiment of the present disclosure.

FIG. 11 is a flow diagram illustrating an example of a flow of an information processing method according to the embodiment of the present disclosure.

FIG. 12 is a configuration diagram illustrating a configuration of the IoT router and a circuit configuration according to the embodiment of the present disclosure.

FIG. 13 is a system configuration diagram illustrating an example of a configuration of a support system according to another embodiment of the present disclosure.

FIG. 14 is a flow diagram illustrating an example of a flow of a support method according to another embodiment of the present disclosure.

FIG. 15 is a conceptual diagram illustrating an example of a menu card according 5 to another embodiment of the present disclosure.

FIG. 16 is a conceptual diagram illustrating an example of a menu card according to another embodiment of the present disclosure.

FIG. 17 is a conceptual diagram illustrating an example of a menu card according to another embodiment of the present disclosure.

### DESCRIPTION OF EMBODIMENTS

First, an embodiment of an IoT connection system in an embodiment of the present disclosure will be described with reference to the drawings.

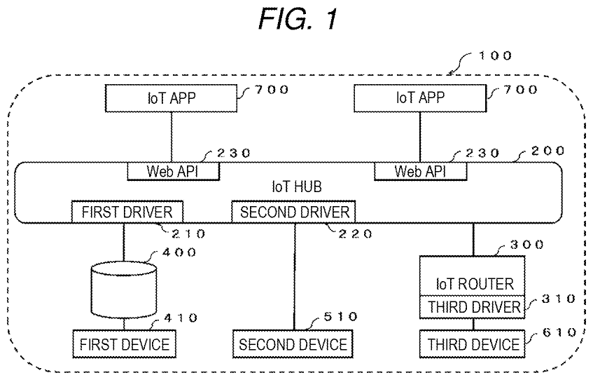

As illustrated in FIG. 1, it is assumed that an IoT connection system 100 in an embodiment of the present disclosure includes an IoT hub 200 and an IoT router 300.

It is assumed that the IoT hub 200 is implemented on a cloud. Specifically, the IoT hub 200 is a managed service which is hosted in a cloud and functions as a repeater for two-way communication between an IoT application (hereinafter referred to as an “IoT app”) and an IoT device.

It is assumed that the IoT router 300 is locally located and connected to the IoT hub 200 by a wide area network (WAN).

Specifically, the IoT router 300 enables an IoT device that is not connected to the Internet, such as a home network, to be connected to the IoT hub 200.

In addition, the IoT hub 200 includes at least one of a first driver 210 and a second driver 220.

The first driver 210 and the second driver 220 absorb differences in specifications for each manufacturer of each IoT device.

The first driver 210 is used to connect a private cloud 400 to which the first device 410 is connectable, and the IoT hub 200.

As an example, it is preferable that the first device 410 and the private cloud 400 be connected to each other via a local area network (LAN), and the private cloud 400 and the first driver 210 be connected to each other via a WAN.

The private cloud 400 is provided by a business operator of the first device 410. Although FIG. 1 illustrates a case where there is one private cloud 400, the number of private clouds is not limited to one, and a plurality of private clouds 400 can be connected to the IoT hub 200. In addition, the IoT hub 200 may include a plurality of first drivers 210.

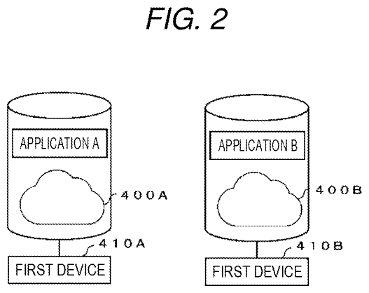

FIG. 2 illustrates details of two private clouds 400A and 400B that are provided by different business operators A and B. As illustrated in FIG. 2, the private cloud 400A is connected to an application A (hereinafter referred to as an “app A”) provided by the business operator A and provides a service according to the app A to the first device 410.

Similarly, the private cloud 400B is connected to an application B (hereinafter referred to as an “app B”) provided by the business operator B and provides a service according to the app B to the first device 410.

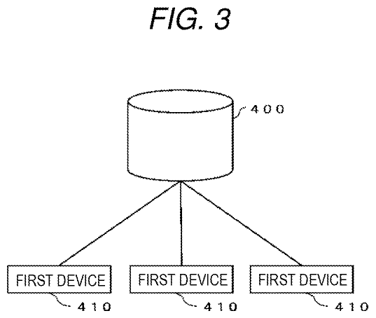

Note that, although FIGS. 1 and 2 illustrate an example in which only one first device 410 is connected to the private cloud 400, a plurality of first devices 410 may be connected to one private cloud 400 as illustrated in FIG. 3.

The first device 410 can be set to be a device to which the business operator provides a private cloud. Examples thereof include an electronic lock having a remote lock function, an AI speaker, a care bed that can be operated remotely, and the like, but are not particularly limited thereto.

Referring back to FIG. 1, the second driver 220 directly connects a second device 510 and the IoT hub 200.

The second device 510 can be connected to the IoT hub 200 on the Internet via a WAN (may be connected via a LAN).

Note that, although FIG. 1 illustrates an example in which only one second device 510 is connected to the second driver 220, a plurality of second devices 510 may be connected to one second driver 220. In addition, the IoT hub 200 may include a plurality of second drivers 220.

The second device 510 can be set to be a device to which the business operator does not provide a private cloud. Examples thereof include a fan, an air conditioner, a window, a curtain, lighting, and the like, but are not particularly limited thereto.

In addition, the IoT router 300 includes a third driver 310. In addition, the IoT router 300 may include a plurality of third drivers 310.

The third driver 310 is used to connect a third device 610 and the IoT router 300.

As an example, it is preferable that the third device 610 and the third driver 310 be connected to each other via a LAN, and the IoT router 300 and the IoT hub 200 be connected to each other via a WAN.

As described above, the third device 610 can be set to be an IoT device that is not connected to the Internet such as a home network. In addition, the third device 610 can be set to be a device that should not be directly connected to the IoT hub 200 from the viewpoints of security, privacy and safety. As an example, the third device 610 can be set to be a gas stove, a face authentication device, a data logger for collecting sensor information, or the like, but it is not particularly limited thereto. However, the third device 610 may be connected to the IoT router 300 irrespective of the kind of the third device 610 from the viewpoint of reducing risk at the time of a disaster to be described later.

In this manner, the IoT connection system 100 of the present invention is a hybrid type IoT connection system that does not directly connect all devices to the IoT hub 200 on the cloud, but connects some devices to the IoT router 300 locally.

According to the above description, it is possible to easily interconnect not only IoT devices that are directly connected to each other, but also IoT devices that are connected to a private cloud of the related art.

Thereby, IoT devices manufactured by various manufacturers can be easily interconnected, unlike the related art in which only IoT devices manufactured by fixed manufacturers have been connected to each other. In addition, it is possible to create unique services that have never existed before by interconnecting IoT devices manufactured by various manufacturers.

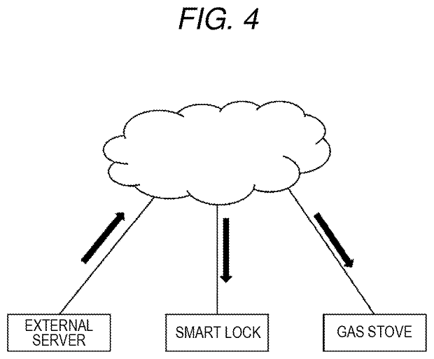

For example, according to the IoT connection system 100 of the present invention, as illustrated in FIG. 4, it is also possible to easily implement services such as transmitting a fire extinguishing signal to a gas stove and unlocking a front door when an emergency earthquake bulletin is received from an external server.

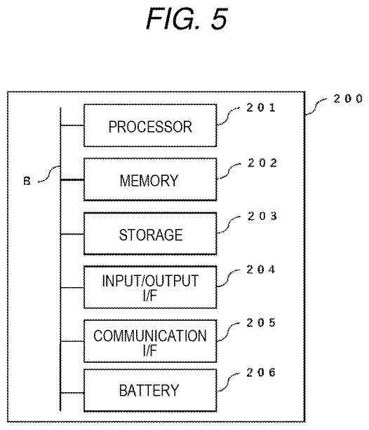

Here, a hardware configuration of an information processing terminal (IoT hub) 200 will be described using FIG. 5. The information processing terminal 200 can include a processor 201, a memory 202, storage 203, an input/output interface (input/output I/F) 204, and a communication interface (communication I/F) 205. The components are connected to each other via a bus B.

The information processing terminal 200 can implement functions and methods

described in this embodiment through cooperation with the processor 201, the memory 202, the storage 203, the input/output I/F 204, and the communication I/F 205.

The processor 201 executes functions and/or methods implemented by codes or commands included in programs stored in the storage 203. The processor 201 includes, for example, a central processing unit (CPU), a micro processing unit (MPU), a graphics processing unit (GPU), a microprocessor, a processor core, a multiprocessor, an application-specific integrated circuit (ASIC), a field programmable gate array (FPGA), and the like, and may implement each processing disclosed in each embodiment by a logic circuit (hardware) or a dedicated circuit formed in an integrated circuit (IC) chip, a large scale integration (LSI), or the like. In addition, these circuits may be implemented by one or a plurality of integrated circuits, and a plurality of pieces of processing shown in the embodiments may be implemented by one integrated circuit. In addition, the LSI may be sometimes referred to as a VLSI, a super LSI, an ultra LSI, or the like depending on the degree of integration.

The memory 202 temporarily stores a program loaded from the storage 203 and provides a working area for the processor 201. The memory 202 also temporarily stores various data generated while the processor 201 is executing a program. The memory 202 includes, for example, a random access memory (RAM), a read only memory (ROM), and the like.

The storage 203 stores programs. The storage 203 includes, for example, a hard disk drive (HDD), a solid state drive (SSD), a flash memory, and the like.

The communication I/F 205 is mounted as hardware such as a network adapter, communication software, or a combination thereof, and transmits and receives various data via a network. The communication may be executed in either a wired or wireless manner, and any communication protocol may be used as long as mutual communication can be executed. The communication I/F 205 executes communication with other information processing devices via a network. The communication I/F 205 transmits various data to other information processing devices in response to an instruction received from the processor 201. In addition, the communication I/F 205 receives various data transmitted from other information processing devices and transmits it to the processor 201.

The input/output I/F 204 includes an input device for inputting various operations to the information processing terminal 200 and an output device for outputting processing results processed by the information processing terminal 200. In the input/output I/F 304, the input device and the output device may be integrated with each other, or the input device and output device may be separated from each other.

The input device is implemented by any one or a combination of all types of devices that can receive a user's input and transmit information related to the input to the processor 201. The input device includes, for example, a touch panel, a touch display, and hardware keys such as a keyboard, a pointing device such as a mouse, a camera (the input of an operation using images), and a microphone (the input of an operation using sounds).

The output device outputs processing results processed by the processor 201. The output device includes, for example, a touch panel, a speaker, and the like.

The IoT router 300 described above can also have the same hardware configuration as that of the IoT hub 200 described above.

In addition, it is preferable that the IoT router 300 be an information processing terminal that can communicate with a predetermined base station.

As an example, an information processing terminal that can communicate with a predetermined base station is an information processing terminal used by inserting a SIM card, such as a smartphone or a tablet terminal. Since the communication capacity between the IoT router 300 and the IoT hub 200 is as low as 100 Mbytes or less per month, it is sufficient to insert a low-cost SIM card with a small communication capacity into the IoT router 300.

In addition, it is assumed that the IoT router 300 includes a battery. Such a battery can store electric power by charging. The IoT router 300 can implement the functions in the present disclosure without being connected to a power supply for approximately three days after being fully charged. In normal times (not under a specific situation to be described later), it is assumed that the IoT router 300 is used by being connected to a power supply.

In addition, the third device 610 can be connected to the IoT hub 200 by a tethering function provided by the IoT router 300 under a specific situation.

The specific situation can be a situation where connection between the third device 610 and a predetermined wireless/wired LAN is lost, or the like, but is not limited thereto.

A power failure can be the cause of falling into such a specific situation, but it is not limited thereto, and Wi-Fi (registered trademark) router failures, connection failures, and the like can be the cause thereof.

In addition, known technology can be used as the tethering function, and methods such as Wi-Fi tethering, Bluetooth (registered trademark) tethering, and USB tethering can be used.

According to the above-described configuration, it is possible to provide attractive services by freely interconnecting IoT in daily life, which is in a siloed state for each private cloud, via the Internet.

Specifically, according to the present disclosure, not only IoT devices that are directly connected to each other, but also IoT devices that are connected to a private cloud of the related art can be easily interconnected.

In addition, according to the above-described configuration, the third device 610 can be connected to the IoT hub 200 by the tethering function of the IoT router 300 under a specific situation, and thus it is possible to continuously use a service even in a state where the IoT device cannot be connected to the network due to a disaster or the like. In addition, it is preferable that the IoT router 300 can be remotely controlled by an administrator device. With such a configuration, each IoT router can be fully supported.

Note that the above-mentioned remote operation is implemented by installing dedicated applications in both the administrator device and the IoT router 300. Note that it is preferable to use an Android terminal for the information processing terminal as the IoT router 300 in consideration of the ease of supporting the remote operation.

In addition, the IoT router 300 is preferably subjected to connected device management (CDM: various device management) by the administrator device. Such CDM can be implemented using a known mobile device management (MDM) method. With such a configuration, IoT routers installed in a large number of households can be centrally managed immediately, remotely monitored, and updated. In addition, CDM enables remote monitoring and control of device settings, application distribution, and updates. Thereby, cost reduction and operational efficiency can be implemented.

In addition, only authenticated applications and devices can be connected to the IoT hub 200, but the IoT router 300 extends the IoT hub 200 locally (inside a house, or the like) to make it possible to secure real-time performance, security, and privacy, and cope with a reduction in communications traffic, and the like that can only be achieved locally.

In addition, by using the IoT router 300 as an information processing terminal, there is no need to use a customer's smartphone or an Internet line in a home, and the risk of unexpected troubles occurring can be reduced.

Further, in the IoT connection system 100 of the present invention, information to be described by a user to create the first driver 210, the second driver 220, and the third driver 310 may be limited to information related to device definition and command definition.

Here, a method of creating the first driver 210, the second driver 220, and the third driver 310 is described. Note that a creator can be a user related to the manufacturing and development of IoT devices, or a user related to the provision of the IoT connection system of the present invention.

Note that it is only required that information of the same contents may be described in the first driver 210, the second driver 220, and the third driver 310, and programming languages thereof may be different from each other.

First, the creator defines a list of devices to be used as a device definition. As an example, in a case where “weather sensor”, “indoor sensor”, “outdoor sensor”, “suspicious person sensor”, “approval sensor”, and “power sensor” are defined as devices to be used, these names and their IDs “weather”, “inhouse”, “outdoor”, “security”, “approve”, and “power” are described.

Next, the creator defines available commands as command definitions. As an example, in a case where an available command for “outdoor sensor” is defined, an observation command of a sensor value is described. The observation command can be, for example, “observe”, “get”. “observe the outdoors”, and the like.

The creator fills information regarding the above-described device definition and command definition in a program in a fill-in-hole format, and thus the first driver 210, the second driver 220, and the third driver 310 can be completed. The other parts can be provided by a provider as an SDK.

It is assumed that the SDK part includes a part related to device operation processing corresponding to a received command, a part related to preprocessing of collected sensor data/operation result data, and a part related to data transmission processing to an IoT hub.

With the above-described configuration, drivers for various types of IoT devices can be easily completed, and thus it is possible to implement an IoT connection system that can connect the IoT devices flexibly and easily.

Engineers related to the development of devices usually have different technical fields from Web development engineers, and many of them do not have a technical level to connect devices to an IoT hub.

For this reason, as in the present disclosure, it is extremely useful to be able to create the drivers by a simple method in a fill-in-hole format common to any driver program. Thereby, it is possible to more reduce development costs and a development period related to connection of IoT devices to an IoT hub than in the related art.

In addition, even when there is a difference in an allowable value of costs due to a reduction in development costs as in an electric fan and an air conditioner, it is possible to implement connection to an IoT hub equally.

Next, connection between the IoT hub 200 and an IoT app related to the IoT connection system 100 in the present disclosure will be described.

As illustrated in FIG. 1, the IoT hub 200 can have a Web API 230 for using an IoT app 700. Note that, as illustrated in FIG. 1, the IoT apps 700 can be connected as many times as the number of services and can be connected using the respective Web APIs 230.

The IoT app 700 is created by describing data acquisition logic from an IoT device (sensor) and/or operation logic of the IoT device in an application.

The data acquisition logic is constituted by a part that preprocesses acquired sensor data and a part that transmits the sensor data to the API of the IoT hub 200. Required information includes a connection destination URL provided by an operator of the IoT connection system 100, an API key provided by the operator, device information, and an execution command.

The device operation logic is constituted by a part that preprocesses a device command desired to be operated and a part that transmits the device command to the API of the IoT hub 200. Required information includes a connection destination URL provided by the operator of the IoT connection system 100, an API key provided by the operator, device information, and an execution command.

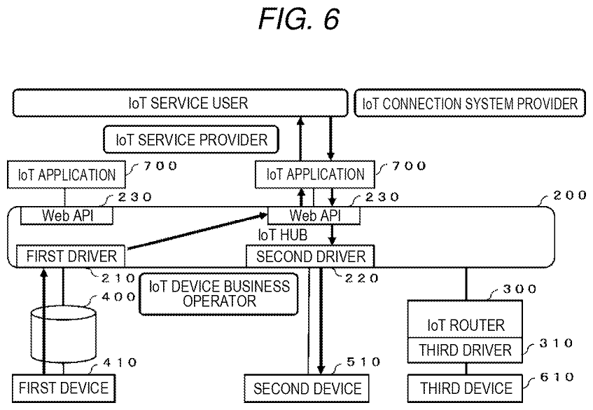

FIG. 6 is a diagram illustrating a flow in which an IoT service user (end user) receives an IoT service provided by an IoT service provider by using an IoT device provided by an IoT device business operator. As illustrated in FIG. 6, first, when the first device 410 gives notice of an event, the end user is notified of the event through the private cloud 400, the first driver 210, the Web API 230, and the IoT app 700.

Subsequently, when the end user determines an action, the second device 510 is instructed to execute the action through the IoT app 700, the Web API 230, and the second driver 220.

The association of IoT devices can be expressed by an event-driven program such as “When ˜ happens, do AA”. In addition, this processing can be implemented as a function of Function as a Service (FaaS) after commercializing the processing as a microservice so that the processing can be shared and used.

Incidentally, the first to third devices, which are the above-described IoT devices, have been developed and manufactured by various manufacturers according to the recent development of an IoT field. However, there has been a problem that continuous connection to a device or an IoT app is limited to devices that can be connected to servers for push notification services provided by major vendors such as Google and Apple.

The IoT hub 200 in the present disclosure is characterized by implementing a continuous connection function and a directory function for the purpose of associating all IoT devices.

The continuous connection function is a function of continuously connecting the first device 410, the second device 510, the third device 610, an IoT service (IOT app 700) that can be used via the IoT hub 200 to each other.

However, there are two types of IoT devices connected to an IoT hub, that is, those that do not necessarily require continuous connection and those that necessarily require continuous connection. The former includes a sensor-based device that periodically or irregularly transmits information. The latter includes devices such as controllable devices that need to be remotely controlled. Accordingly, it is only required that the continuous connection function in the present disclosure implements continuous connection for the latter IoT device that necessarily requires continuous connection, and implements connection limited to the time required for the former IoT device that does not necessarily require continuous connection.

The continuous connection function can make it possible to implement the IoT hub 200, the first device 410, the second device 510, the third device 610, and the IoT service 700 in the present disclosure using a communication protocol such as message queue telemetry transport (MQTT) for IoT.

In addition, the directory function associates the first device 410, the second device 510, the third device 610, and an IoT service with each other.

That is, the directory function implements a function of specifying a thing or a service from a certain thing (device) to a certain service, from a certain service to a certain thing, from a certain thing to a certain thing and giving an instruction to the thing or the service.

In addition, the directory function makes it possible to specify an association destination device designated by an association source device on the basis of identification information of the device, identification information of a driver, and identification information of a connection interface.

The identification information of the device is a universally unique identifier (UUID) of the IoT device. The identification information of the driver is an ID of the driver. The identification information of the connection interface is information for specifying an R interface which is an interface between the driver and the IoT hub.

In addition, the directory function can further specify an association destination device on the basis of identification information of the IoT hub 200.

Note that the identification information of the device, the identification information of the driver, and the identification information of the connection interface are stored in a predetermined storage device, and the storage device can further store identification information of a connection source device for which connection is not permitted, and/or a function of the device as a whitelist. For such a list, a menu card of a support method to be described later can be used.

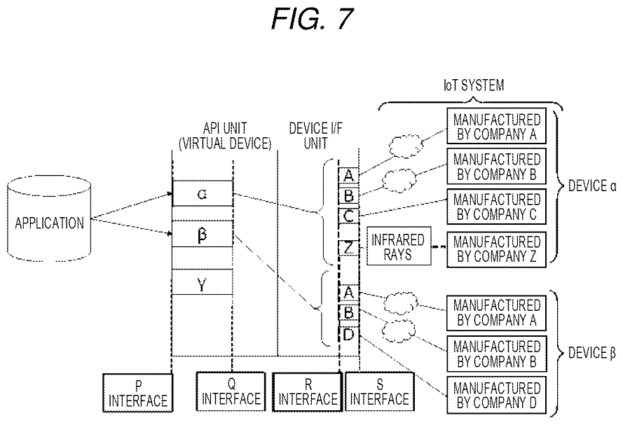

FIG. 7 is a conceptual diagram illustrating the structure of an interconnection infrastructure in the IoT connection system in the present disclosure. As illustrated in FIG. 7, a connection surface between an IoT app shown as an application and an IoT hub is a P-interface, but can have a standardized Q-interface by connection using a Web API (α, β, γ).

Similarly, a connection surface between an IoT device and an IoT hub is an S-interface, but can have a standardized R-interface by connection using drivers (A to Z).

In the related art, an IoT app needs to designate an IoT device serving as a destination on the IoT app side in order to transmit and receive information to and from an embedded application of an IoT device, and the IoT device side also needs to have identification information that can be designated by the IoT app.

On the other hand, in the IoT connection system of the present disclosure, the destination is designated by a directory function implemented by the IoT hub.

For example, addition or replacement of an IoT device can be handled only by adding a driver to the IoT hub and adding or switching a connection destination, and it is not necessary to modify the IoT app itself.

That is, a destination part for designating an IoT device required in the IoT app, and an identification information part that can be designated from the IoT app required in the IoT device can be aggregated in any IoT hub.

For this reason, the addition or replacement of IoT devices does not increase the man-hours of application developers and leads to cost reduction.

In this manner, according to the IoT connection system in the present disclosure, it is possible to implement protocol-free interconnection by connection to the IoT hub even when the manufacturers and models of IoT devices are different.

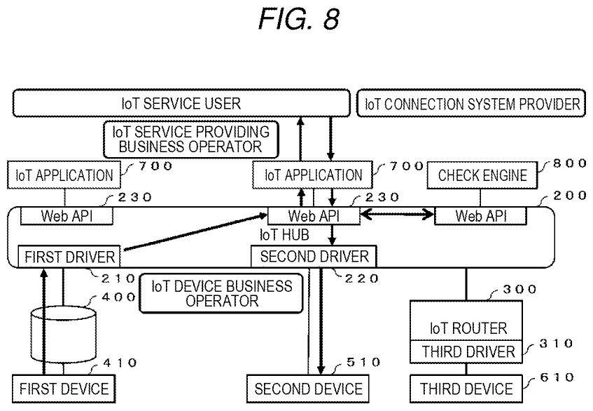

In addition, as illustrated in FIG. 8, the IoT hub 200 of the present invention can be connected to a checkpoint 800. The checkpoint 800 is used to check what instruction the IoT hub 200 gives to a device and prevent an inappropriate action from being executed.

For example, in a case where an IoT service such as “when the outside air is fresh, turn off the air conditioner and open the window” is provided, there is a concern that the room may get wet when guerrilla heavy rain hits immediately after, but the checkpoint 800 is used to prevent such a threat derived from IoT.

In addition, at least one of the first driver 210, the second driver 220, and the third driver 310 of the present invention can implement a virtual device function.

The virtual device function virtually reproduces the first device 410, the second device 510, or the third device 610.

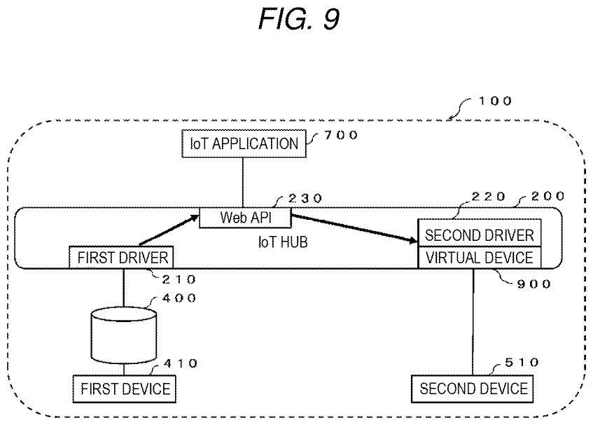

FIG. 9 illustrates an example in which the second driver 220 of the present invention implements a virtual device function. As illustrated in FIG. 9, the second driver 220 is provided with a virtual device 900 that can reproduce the transmission and reception of a command of the second device 510, and thus it is possible to develop an IoT app using the second device 510 even when the second device 510 is not connected. In addition, when there is an operation failure, it is possible to easily perform failure isolation regarding which one of the second device 510 and the IoT hub 200 has failed without going to the site.

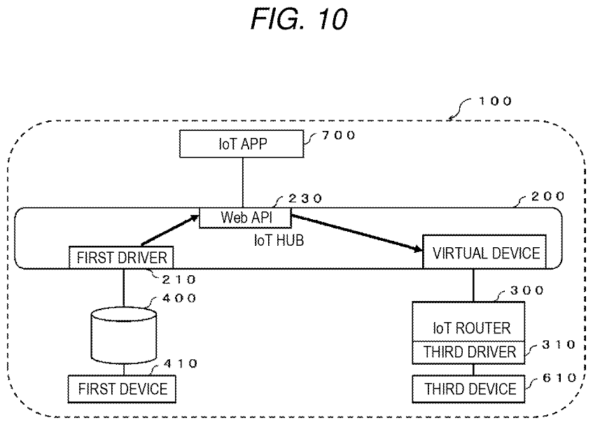

Further, in the present invention, as illustrated in FIG. 10, the IoT hub 200 may implement the virtual device function instead of the driver. This is an effective means for failure isolation of the third device 610 connected to the locally existing IoT router 300.

As described above, the IoT hub in the present disclosure is a protocol-free infrastructure that enables interconnection between clouds by an interface called a driver even when the clouds use different communication protocols. In addition, it is also possible to combine and connect a plurality of applications and IoT devices in a complex manner with the directory function.

As an example, the IoT hub in the present disclosure can also be applied to electric vehicle charging services.

In recent years, it has been common practice to generate solar power at home and charge an electric vehicle with the surplus power generated. An electric vehicle used for commutation or the like starts charging when a user inserts a predetermined charging plug when the electric vehicle returns to a garage.

However, there is a problem that it is difficult to charge an electric vehicle at an appropriate timing because a user is often not at home with the electric vehicle at the point in time when surplus power, which is usually generated during the daytime, is generated.

For this reason, it is possible to charge electric vehicles at charging spots installed in the city, but the inconvenience of having to purchase electricity at the charging spots occurs in spite of the generation of surplus electricity at home.

Such inconvenience can be resolved by applying the IoT connection system of the present disclosure. Specifically, an IoT sensor that detects surplus power generation is installed in a power generation system at home. In a case where the surplus power generation is detected by the IoT sensor, charging of an electric vehicle connected to another charging device is started through the IoT hub in the present disclosure.

In this manner, according to the IoT connection system of the present disclosure, it is possible to associate services such as charging services of a solar power generation system and an electric vehicle provided by different business operators.

Subsequently, an embodiment of an information processing method in the present disclosure will be described with reference to the drawings.

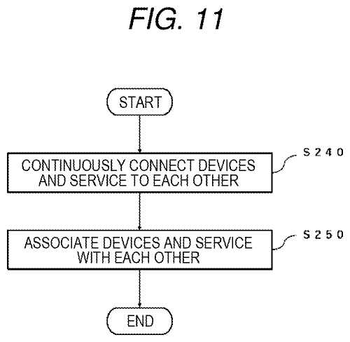

The information processing method in the present disclosure is an information processing method in an IoT connection system including an IoT hub implemented on a cloud and an IoT router locally located and connected to the IoThub as illustrated in FIG. 11, and is characterized by having the IoT hub execute a continuous connection step S240 and a directory step S250).

As illustrated in FIG. 1, the IoT hub includes at least one of the first driver for connecting a private cloud to which the first device is connectable and the IoT hub, and the second driver for connecting the second device and the IoT hub, and the IoT router includes the third driver for connecting the third device and the IoT router.

In the continuous connection step S240, the first device, the second device, the third device, and an IoT service that can be used via the IoThub are continuously connected to each other.

In the directory step S250, the first device, the second device, the third device, and the IoT service are associated with each other.

According to the above description, it is possible to easily interconnect not only IoT devices that are directly connected to each other, but also IoT devices that are connected to a private cloud of the related art.

Subsequently, an embodiment of a computer program in the present disclosure will be described with reference to the drawings.

The computer program in the present disclosure is a computer program executed by the IoT connection system including the IoT hub implemented on the cloud and the IoT router locally located and connected to the IoT hub, and is characterized by causing the IoT hub to execute a continuous connection function and a directory function.

The IoT hub includes at least one of the first driver for connecting a private cloud to which the first device is connectable and the IoT hub, and the second driver for connecting the second device and the IoT hub.

The IoT router includes the third driver for connecting the third device and the IoT router.

The continuous connection function is used to continuously connect the first device, the second device, the third device, and an IoT service that can be used via the IoT hub to each other.

The directory function is used to associate the first device, the second device, the third device, and the IoT service with each other.

According to the above description, it is possible to easily interconnect not only IoT devices directly connected to each other, but also IoT devices connected to a private cloud of the related art.

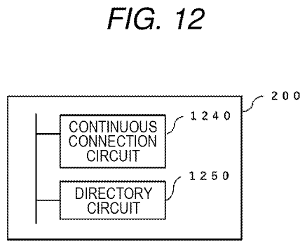

The above-described functions can be implemented by a continuous connection circuit 1240 and a directory circuit 1250 illustrated in FIG. 12.

Further, in the IoT connection system 100 of the present invention, information acquired from the first device 410, the second device 510, or the third device 610 cannot be stored in the IoT hub 200.

The IoT connection system 100 of the present invention is assumed to be operated by a telecommunications business operator. Since the telecommunications business operator is obliged to observe the secret of communication, information acquired from various devices is not stored for the purpose of other utilization.

Since this information is useful information, it is normal for each company's private cloud to enclose IoT devices in order to acquire such information exclusively.

On the other hand, the IoT connection system 100 of the present invention can interconnect IoT devices and an IoT app from a neutral standpoint and promote IoT business by being operated by a telecommunications business operator.

In addition, since the continuity of an IoT interconnection service affects the continuity of IoT services of companies that use it, it is preferable that the companies that use it jointly share interconnection infrastructure.

Further, in the IoT connection system 100 of the present invention, only devices and IoT apps permitted by API keys and authentication schemes can be connected to the IoT hub 200. That is, the IoT connection system 100 of the present invention can construct a closed network dedicated to IoT communication on the Internet. In addition, a communication path is also encrypted and the IoT router is managed using a mobile device management (MDM) method, and thus it is also possible to cope with new attack methods, and an OS vulnerability or an application vulnerability.

In addition, in order to connect a device that has not been converted to IoT to the IoT hub 200, development can be performed in a short period of time by using Backend as a service (BaaS) and an SDK.

In addition, the provider of the IoT connection system 100 can propose an interconnection support service for an IoT device. Specifically, it is possible to provide business matching and consulting services. That is, in order to add value, it is possible to find a necessary partner, introduce a value creation pattern and best practices, and the like.

In addition, it is possible to create attractive services by combining with other companies' devices and applications and expand business by appealing for added value.

Subsequently, an embodiment of a support method which is another embodiment in the present disclosure will be described.

The support method in another embodiment of the present disclosure is a support method for supporting the creation of new services in which functions of a plurality of devices are combined, via an IoT hub to which the plurality of devices are connected.

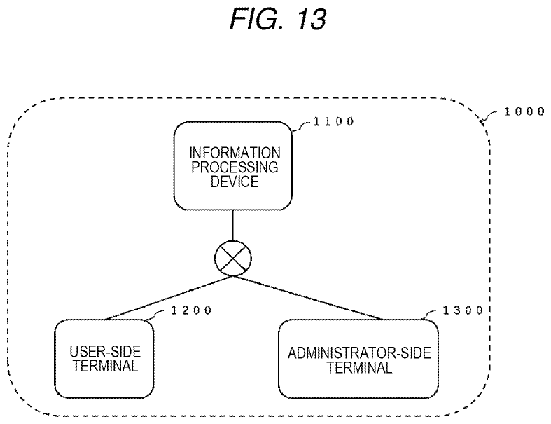

The above-described support method is executed in a support system illustrated in FIG. 13. A support system 1000 illustrated in FIG. 13 can include an information processing device 1110, a user-side terminal 1120, and an administrator-side terminal 1130.

Hereinafter, description will be given on the assumption that a connection business operator (company B) that applies for association is a first user, a connection business operator (company A) to which the first user applies for association is a second user, and a business operator (company C) that intermediates between the first user and the second user is a third user.

As an example, it is assumed that the first user is a user who provides a face authentication device, and the second user is a user who provides an electronic lock device.

In addition, the first user is set to be a person who attempts to create a service for associating a face authentication function, which is a function of the face authentication device, with a door lock open/close function, which is a function of the electronic lock device, to unlock the door when permitted by the face authentication function.

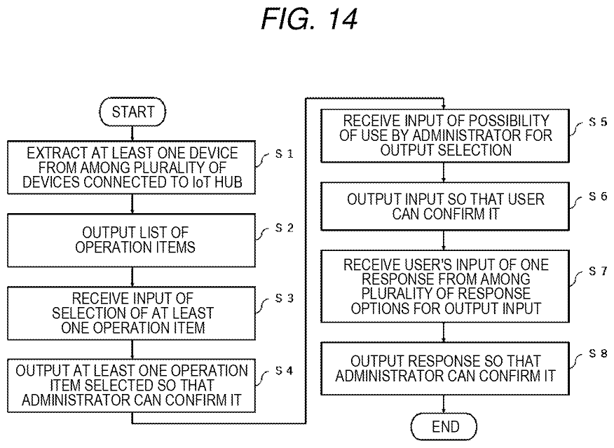

Here, the support method of the present invention causes the information processing device 1110 to execute an extraction step S1, as illustrated in FIG. 14.

In the extraction step S1, at least one device capable of implementing a function requested by a user (first user) is extracted from among the plurality of devices connected to the IoT hub.

For example, in a case where the function requested by the first user is the door lock open/close function, a device having such a function, for example, the electronic lock device of the second user, is extracted. Note that a plurality of devices may be extracted as a device having the door lock open/close function.

Further, in order to perform the above-described extraction, it is assumed that a database related to device information is stored in a storage device included in the information processing device 1110 or connected to the information processing device 1110.

It is assumed that pieces of information such as the ID, name, function, and provider of a device are associated with each other as device information in the database. Note that the information included in the device information is not limited thereto, and various information can be associated as device information.

Further, the input of the function requested by the first user may be selected from previously prepared function items that can be provided. Such function items can be automatically generated on the basis of the database.

Alternatively, in the extraction step S1, it is assumed that at least one device is extracted from the plurality of devices connected to the IoT hub on the basis of the user's designation.

The above-described configuration is effective when the first user has specified in advance a device with which the first user desires to perform association.

Further, as illustrated in FIG. 14, the support method of the present invention further includes a list output step S2, a selection reception step S3, a selection output step S4, a possibility reception step S5, an input/output step S6, a response reception step S7, and a transmission step S8.

In the list output step S2, a list of device operation items extracted in the extraction step S1 is output so that the user can confirm them.

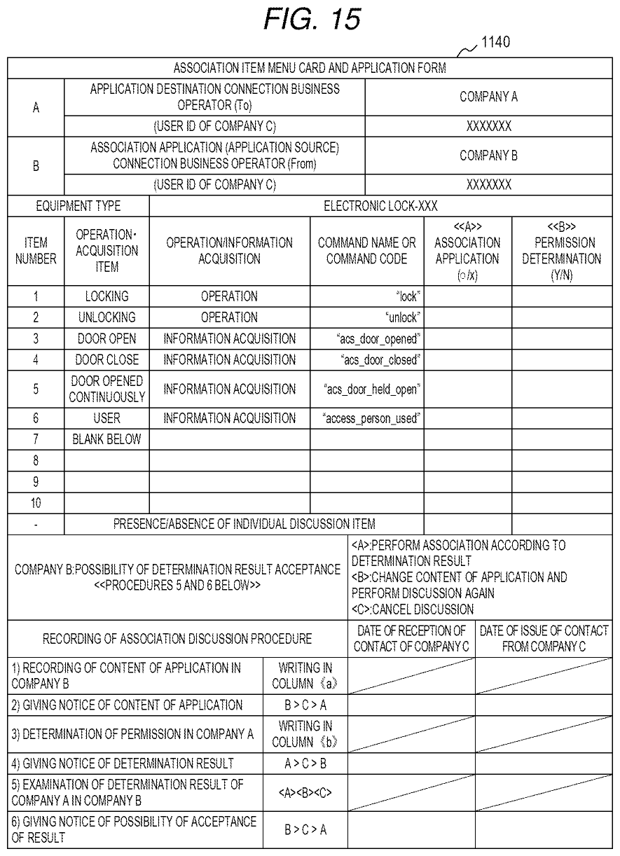

FIG. 15 illustrates an image of an association item menu card and application form 1140 (hereinafter referred to as a “menu card 1140”) that includes a list of operation items. The menu card 1140 is output to the user-side terminal 1120 that can be confirmed by the user and displayed on a display screen of the user-side terminal 1120, but the menu card 1140 can also be used by being output to a paper medium. In FIG. 15, the first user is shown as a company B, the second user is shown as a company A. and the third user is shown as a company C.

Further, in FIG. 15, the list of operation items is described in the column of “operation/acquisition item”. Note that it is assumed that an “acquisition item” is included in the operation items in the present invention as an operation of acquiring information.

In addition, whether an item is related to “operation” or “information acquisition” is also described in association with the operation item. In addition, a “command name” or a “command code” required for association may also be described in advance.

Further, in the selection reception step S3, an input of selection of at least one operation item by the user from the list of the operation items output in the list output step S2 is received.

As an example, the user inputs “o” or “x” in an association application column of the menu card 1140 as illustrated in FIG. 15. Such an input can be performed by operating the user-side terminal 1120 or by being written on the output paper medium.

In the latter case, it is preferable that the selection written on the paper medium be input to the information processing device 1110 by the third user.

In the selection output step S4, at least one operation item selected by the user based on the input received in the selection reception step S3 is output so that the administrator of the device extracted in the extraction step can confirm it.

As an example, it is assumed that the menu card 1140 having the association application column filled in, as illustrated in FIG. 15, is output to the administrator-side terminal 1130 that can be confirmed by the administrator and is displayed on the display screen of the administrator-side terminal 1130, but the menu card 1140 can also be used by being output to a paper medium.

In the possibility reception step S5, the input of the possibility of use by the administrator for the selection output in the selection output step S4 is received.

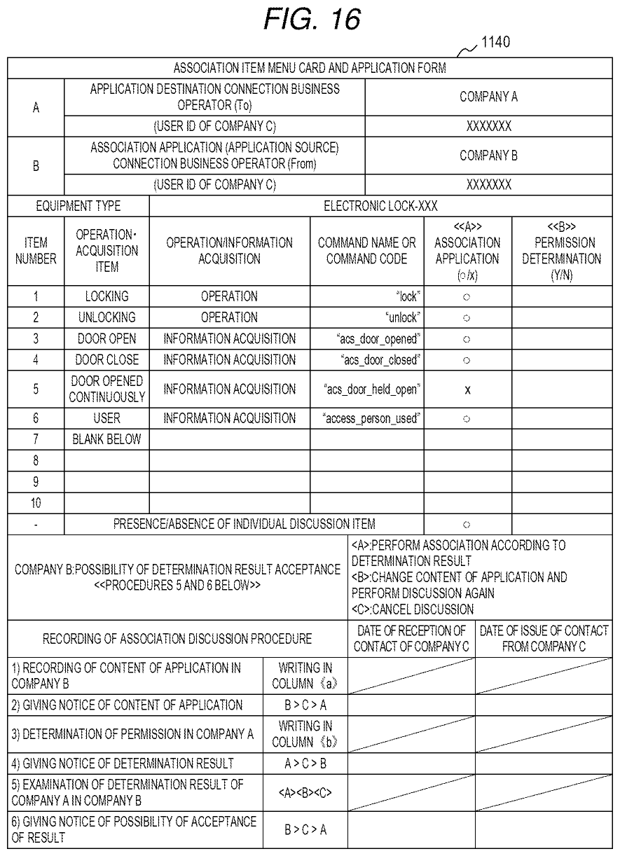

As an example, as illustrated in FIG. 16, the administrator inputs “Y (YES)”, “N (NO)”, or “n/a (not available)” in a permission determination column of the menu card 1140. Such an input can be performed by operating the administrator-side terminal 1130 or by being written on the output paper medium. In the latter case, it is preferable that the selection written on the paper medium be input to the information processing device 1110 by the third user.

In the input/output step S6, the input received in the possibility reception step S5 is output so that the user can confirm it.

As an example, it is assumed that the menu card 1140 having the permission determination column filled in, as illustrated in FIG. 16, is output to the user-side terminal 1120 that can be confirmed by the user and is displayed on the display screen of the user-side terminal 1120, but the menu card 1140 can also be used by being output to a paper medium.

In the response reception step S7, the user's input of one response is received from among a plurality of response options for the input output in the input/output step S6.

As an example, the user selects a response from “<A>: Perform association according to determination result”, “<B>: Change content of application and perform discussion again” or “<C>: Cancel discussion.” Such an input of selection can be performed by operating the user-side terminal 1120 or by being written on the output paper medium. At this time, it is preferable that the selection written on the paper medium be input to the information processing device 1110 by the third user.

In the transmission step S8, the response received in the response reception step S7 is output so that the administrator can confirm it.

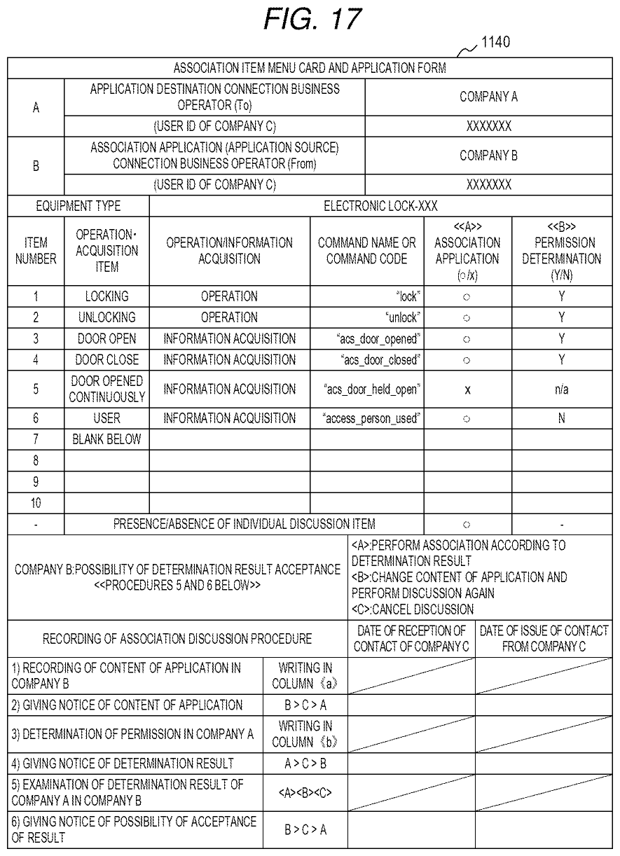

As an example, it is assumed that the menu card 1140 having the response filled in, as illustrated in FIG. 17, is output to the administrator-side terminal 1130 that can be confirmed by the administrator and is displayed on the display screen of the administrator-side terminal 1130, but the menu card 1140 can also be used by being output to a paper medium.

According to the above-described configuration, it is possible to provide a technical improvement for solving or mitigating at least some of the above-described problems of the related art. In addition, according to the above-described configuration, it is possible to efficiently create new services in which functions of a plurality of devices are combined.

Further, in the extraction step S1, at least one device capable of implementing a function requested by the user (first user) is automatically extracted from the plurality of devices connected to the IoT hub, and thus it is possible to reduce the burden on work of extracting a device which is an association destination and efficiently create new services.

In addition, the information processing device (third user) mediates the menu card, and thus it is possible to reduce the burden on work related to a contract and efficiently create new services.

In addition, as an embodiment of the present invention, as described above, in the list output step S2, the information processing device may output the list of device operation items extracted in the extraction step to the user-side terminal that can be confirmed by the user.

Further, in the selection reception step S3, the information processing device 1110 may receive the user's input of selection of at least one operation item from the list of operation items output in the list output step S2 from the user-side terminal 1120.

Further, in the input/output step S6, the information processing device 1110 may output the input received in the possibility reception step S5 to the user-side terminal 1120 that can be confirmed by the user.

Further, in the response reception step S7, the information processing device 1110 may receive the user's input of one response from among the plurality of response options for the input output in the input/output step S6 via the user-side terminal 1120.

Further, in the selection output step S4, the information processing device 1110 may output at least one operation item selected by the user to the administrator-side terminal 1130 that can be confirmed by the administrator of the device extracted in the extraction step S1 on the basis of the input received in the selection reception step S3.

Further, in the possibility reception step S5, the information processing device 1110 may receive an input of the possibility of use by the administrator for the selection output in the selection output step S4 from the administrator-side terminal 1130.

Further, in the transmission step S8, the information processing device 1110 may output the response received in the response reception step S7 to the administrator-side terminal 1130 that can be confirmed by the administrator.

According to the above-described configuration, it is possible to provide a technical improvement for solving or mitigating at least some of the above-described problems of the related art. In addition, according to the above-described configuration, it is possible to efficiently create new services in which functions of a plurality of devices are combined.

Although some embodiments of the present invention have been described, these embodiments are presented as examples and are not intended to limit the scope of the invention. These novel embodiments can be embodied in various other forms, and various omissions, replacements, and modifications can be made without departing from the scope of the invention. These embodiments and their modifications are included in the scope and gist of the invention, and are included in the scope of the invention described in the claims and equivalents thereof.

In addition, the methods described in the embodiment can be stored in a storage medium such as a magnetic disk (a floppy (registered trademark) disk, a hard disk, or the like), an optical disk (CD-ROM, DVD, MO, or the like), or a semiconductor memory (a ROM, a RAM, a flash memory, or the like) as a program that can be executed by a computer, and can be transmitted and distributed via a communication medium. Note that the programs stored on the medium side also include a setting program for configuring software means (including not only execution programs but also tables and data structures) executed by the computer in the computer. The computer that implements the present device reads a program recorded on a recording medium, constructs software means by the setting program if necessary, and executes the above-described processing by controlling an operation by the software means. Note that the recording medium mentioned in the present specification is not limited to being used for distribution, and includes a storage medium such as a magnetic disk or a semiconductor memory provided inside the computer or in equipment connected via a network. A storage unit may function as, for example, a main storage device, an auxiliary storage device, or a cache memory.

### REFERENCE SIGNS LIST

100 IoT connection system
200 IoT hub
210 First driver
220 Second driver
230 Web API
300 IoT router
310 Third driver
400 Private cloud
410 First device
510 Second device
610 Third device
700 IoT app
800 Checkpoint
900 Virtual device

1. An internet of things (IOT) connection system, comprising:
an IoT hub; and
an IoT router connected to the IoT hub, wherein
the IoT hub includes at least one of a first driver and a second driver, the first driver configured to connect the IoT hub to a private cloud to which a first device is connectable, and the second driver is configured to connect the IoT hub to a second device,
the IoT router includes a third driver configured to connect the IoT router to a third device, and
the IoT hub is configured to perform
a continuous connection function for continuously connecting the first device, the second device, the third device, and
an IoT service that is usable via the IoT hub to each other, and
a directory function for associating the first device, the second device, the third device, and the IoT service with each other.

2. The IoT connection system according to claim 1, wherein the directory function is used to specify the first device, the second device, the third device, or the IoT service and give an instruction to the first device, the second device, the third device, or the IoT service.

3. The IoT connection system according to claim 1, wherein the directory function is used to specify an association destination device designated by an association source device on the basis of identification information of a device, identification information of a driver, and identification information of a connection interface.

4. The IoT connection system according to claim 3, wherein the directory function is used to further specify the association destination device, on the basis of identification information of the IoT hub.

5. The IoT connection system according to claim 3, wherein
the identification information of the device, the identification information of the driver, and the identification information of the connection interface are stored in a predetermined storage device, and
the storage device further stores identification information of a connection source device for which connection is not permitted, and/or a function of the device as a whitelist.

6. The IoT connection system according to claim 1, wherein at least one of the first driver, the second driver, and the third driver implements a virtual device function for virtually reproducing the first device, the second device, or the third device.

7. The IoT connection system according to claim 1, wherein the IoT hub further includes a Web application programming interface (API) for using an IoT application.

8. The IoT connection system according to claim 1, wherein information acquired from the first device, the second device, or the third device is not stored in the IoT hub.

9. The IoT connection system according to claim 1, wherein the IoT router is able to be remotely controlled by an administrator device.

10. An information processing method in an internet of things (IOT) connection system including an IoT hub, and an IoT router connected to the IoT hub, the IoT hub including at least one of a first driver and a second driver, the first driver is configured to connect the IoT hub to a private cloud to which a first device is connectable, and the second driver is configured to connect the IoT hub to a second device, the IoT router including a third driver configured to connect the IoT router to a third device, the information processing method comprising:
performing a continuous connection step of continuously connecting the first device, the second device, the third device;
performing an IoT service that is usable via the IoT hub to each other and
performing a directory step of associating the first device, the second device, the third device, and the IoT service with each other.

11. A non-transitory computer readable medium storing computer executable instructions which are executed by an IoT connection system including an internet of things (IOT) hub and an IoT router connected to the IoT hub, wherein the IoT hub includes at least one of a first driver and a second driver, the first driver is configured to connect the IoT hub to a private cloud to which a first device is connectable, and the second driver is configured to connect a second device and the IoT hub, the IoT router includes a third driver configured to connect the IoT router to a third device, and when the computer executable instructions are executed by the IoT connection system, the IoT connection system is caused to:
execute a continuous connection function for continuously connecting the first device, the second device, the third device;
an IoT service that is usable via the IoT hub to each other; and
a directory function for associating the first device, the second device, the third device, and the IoT service with each other.
